(19) United States
(12) Patent Application Publication
(10) Pub. No.: US 2006/0137513 A1
(43) Pub. Date: Jun. 29, 2006

(54) Mobile telecommunication apparatus comprising a melody generator

(75) Inventors: Ronan Billon, Le Mans (FR); Severine Loiseau, Paris (FR); Jerome Augui, Meudon (FR); Daniele Cohen, Suresnes (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/545,344

(22) PCT Filed: Jan. 26, 2004
(86) PCT No.: PCT/IB04/00273

§ 371 Date: Aug. 11, 2005

(30) Foreign Application Priority Data
Feb. 14, 2003 (FR) 0301830

(51) Int. Cl. G10H 1/00

(52) U.S. Cl. 84/600

(57) ABSTRACT

This apparatus comprises a melody generator (19) known as synthesizer. This synthesizer allows working with a multitude of channels C1, C2, . . . C9 and at least one of these channels is assigned to process vocal signals particularly coming from a microphone (17). The elaborated melody may be sent to different correspondents by using the functionalities of the transmission method for the apparatus, for example, SMS, electronic mail, etc.

The invention relates to a telecommunication apparatus comprising a melody generator of the type known as synthesizer which can handle different music channels.

The presence of this synthesizer enables the user to combine and/or mix these different channels so as to create melodies, notably for changing the ring tone of his apparatus.

Such an apparatus is mentioned in U.S. Pat. No. 6,426,456 in which it is particularly described as a synthesizer adapted to provide sounds imitating percussion instruments.

The present invention proposes a telecommunication apparatus of the type mentioned in the opening paragraph for which measures are provided to offer the user attractive functionalities.

Among other things, it is possible to mix the voice from different sources, such as the microphone forming part of said apparatus, of a radio receiver for consumer use which may comprise this type of apparatus, or even from a pre-recorded file.

Among other attractive functionalities, it is possible to transmit the music elaborated by the apparatus to other correspondents by way of electronic mail, SMS and even via an infrared interface or a system known as Bluetooth.

These and other aspects of the invention are apparent from and will be elucidated, by way of non-limitative example, with reference to the embodiment(s) described hereinafter.

In these drawings:

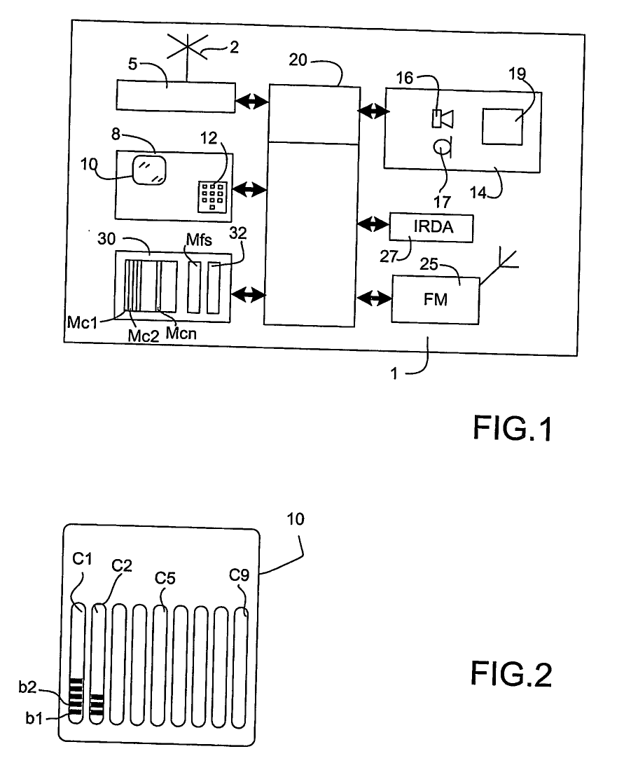

FIG. 1 shows a telecommunication apparatus according to the invention.

FIG. 2 shows a screen on which the music channels are displayed for processing by means of an apparatus according to the invention.

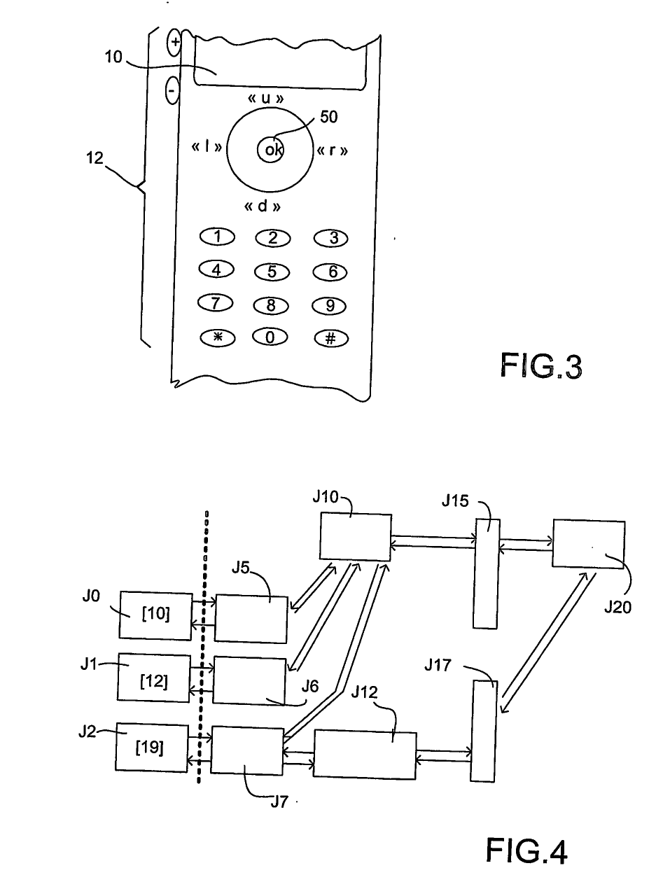

FIG. 3 shows the different keys of the apparatus, used in the invention.

FIG. 4 shows the architecture of the software used by the invention.

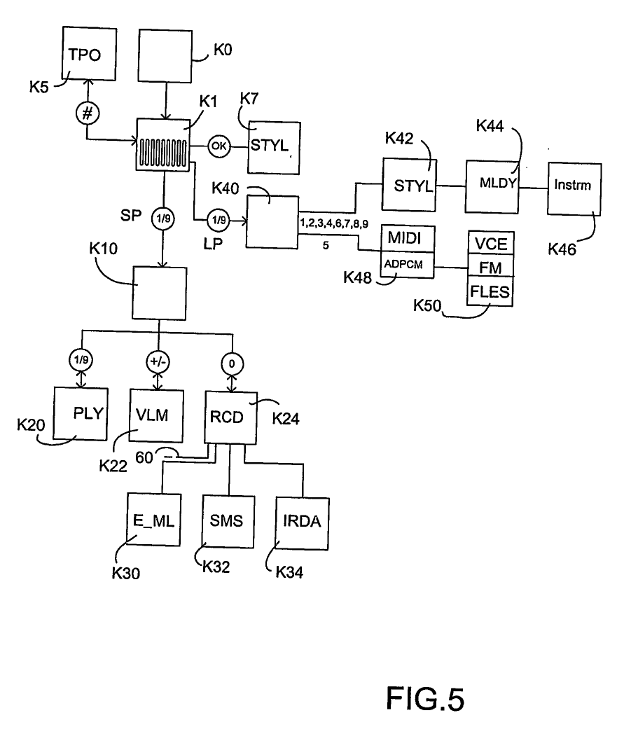

FIG. 5 shows a diagram explaining the invention.

FIG. 1 shows a telecommunication apparatus 1, for example, a radio telephone used in cellular telephone networks. This apparatus comprises an antenna 2 for exchanging information with the network to which it is connected. This antenna 2 is connected to the radioelectric part 5 of the apparatus. This apparatus also comprises a man-machine interface part 8 which comprises the screen 10 and the keyboard 12 and all the associated circuits for its operation. Finally, an audio part 14 is provided, particularly comprising a loudspeaker 16, a microphone 17 and a sound generator 19, for example, the registered trademark circuit ML2802. All of these parts operate in dependence upon a microprocessor system 20. This apparatus also comprises, by way of accessory, a radiophonic receiver 25 for capturing stations in the FM frequency modulation band. It also comprises an infrared-operated communication circuit IRDA, denoted by reference numeral 27. It is also possible to provide a circuit of the Bluetooth type in the same manner.

The operation of this system 20 is determined by a set of instructions contained in a memory set 30 comprising, inter alia, a memory 32 referred to as program memory. The apparatus of the invention comprises a melody generator for which the audio part 14 plays a primordial role. This generator allows a polyphonic elaboration of melodies which can be constituted from several channels. Within the scope of the invention described, these are nine channels and are denoted by the references C1, C2, C3, . . . , C9. These channels are visualized on the screen, as is shown in FIG. 2. Different bars b1, b2 . . . show the intensity of sounds coming from these channels, which sounds can be mixed at levels wanted by the user. The content of these channels is memorized in the memory set 30 at the respective sites Mc1, Mc2, . . . Mcn. “n” may be higher than 9. However, only nine channels are treated by the generator. These channels are managed by visualization on the screen and also by acting on different keys of the keyboard 12, as is shown in FIG. 3. Within the scope of using the generator, the keys 1 to 9 relate to the channels to be treated. It will be noted that there is a navigation button 50 which can take different localizations “u”, “d”, “l”, “r” corresponding to upward and downward movements and to movements to the left and right, respectively. An “ok” key validates, in principle, a command. “+” and “−” buttons on the side of the apparatus particularly allow control of the volume from the loudspeaker 16.

The following diagrams explaining the operation of the apparatus allow those skilled in the art to realize the invention by implementing the adequate instructions in the program memory 32.

FIG. 4 shows a diagram explaining the architecture of the software managing the melody generator. This diagram comprises different boxes. The boxes J0, J1 and J2 represent the components associated with the screen, the keyboard and the generator circuit 19, respectively. These different components require software pilots denoted by J5, J6 and J7, respectively. The reference numeral J10 in this Figure denotes the MMI manager (man-machine interface) which particularly manages all the interactions of the components J0, J1 and J2. The special features of the melody generator of the invention are contained in a software set J12. API programming interfaces J15 and J17 are provided, which have access to the software sets J10 and J12 on the basis of the application J20.

FIG. 5 shows the operation of the apparatus when the music generator is involved. The box K0 shows the info screen of the application. From this box K0, one proceeds spontaneously to the box K1 after a short instant. From this box K1 one may proceed to different boxes representing different functions. By pressing the key #, one proceeds to the box K5 which corresponds to a step in which it is possible to vary the rhythm. After regulating the rhythm, one can return to the box K1 by operating the same key. In this box K1, one may choose the style of the melody and for this purpose operate the ok key and, in box K7, it is possible to choose or change this style. Examples of style may be “Techno”, “Groove”, “Disco” etc.”. From the same box K1, it is possible by means of a short pressure SP on one of the keys 1 to 9 to work on one of the channels 1 to 9, which allows loading of the channel corresponding to the pressed key. One is then in the box K10. By pressing one of the keys 1 to 9, a channel is always played, box K20. In the same box K10, one may vary the volume by operating the “+” and “−” keys, box K22. Pressure of the key “0” allows the current music to be recorded, box K24. After recording, several options are available. This recording may be transmitted in various manners, boxes K30, K32 and K34 showing some of them, while other manners, shown by a broken line 60, are not explicitly mentioned. The box K30 relates to sending the recording by e-mail, the box K32 relates to sending the recording by way of the SMS protocol, and the box K34 allows activation of the IRDA interface.

From box K1, one may also access other possibilities by means of a long pressure LP on one of the keys 1 to 9. This is indicated in box K40. If, in this box, one of the keys from 0 to 9 is pressed, excluding key 5, one ends up at the choice of styles, box K42 and, from this, at melodies, box K44 at the sites Mc1 to Mcn (FIG. 1). These melodies may be played on one of the instruments, the list of which is shown in box K46.

If in this box K40, the key 5 is pressed, this channel 5 can be loaded with a MIDI file or from an analog type of source of the ADPCM type, as is proposed in box K48. When a MIDI file is chosen, this file will be loaded. When the ADPCM option is taken, another choice will be presented, which is indicated in box K50. Either the channel 5 will be loaded with sound directly coming from the microphone 17, or with sound coming from the receiver 25, or from a file of the ADPCM type already stored in the memory 30.

The invention thus relates to a telecommunication apparatus comprising a melody generator of the type known as synthesizer, suitable for managing sounds coming from different channels, and having the following characteristic features:
at least one of the channels can be assigned to vocal signals,
a microphone is provided, to which the generator allocates at least one of the vocal signal channels,
a radiophonic receiver is provided, to which the generator allocates at least one of the vocal signal channels,
access to files is provided, to which the generator allocates at least one of the vocal signal channels,
means are provided for modifying the content of the channels, wherein the files may be of the MIDI type,
means are provided for mixing the sounds of the different channels,
means are provided for recording said sounds created by the user in a music file,
means are provided for using at least one of the transmission methods of the SMS, IRDA, electronic mail or other types, and means are provided for using this method for transmitting said music file,
a ring tone circuit is provided and means are provided for applying said music file to said ring tone circuit,
means are provided for choosing to process a certain number of channels from a multitude of channels,
means are provided for receiving a call from a correspondent and means are provided for saving the music files during their realization.

1. A telecommunication apparatus comprising a melody generator of the type known as synthesizer, suitable for managing sounds from different channels.

2. An apparatus as claimed in claim 1, wherein at least one of the channels can be assigned to vocal signals.

3. An apparatus as claimed in claim 2, comprising a microphone to which the generator allocates at least one of the vocal signal channels.

4. An apparatus as claimed in claim 2, comprising a radiophonic receiver to which the generator allocates at least one of the vocal signal channels.

5. An apparatus as claimed in claim 2, comprising means for access to files to which the generator allocates at least one of the vocal signal channels.

6. An apparatus as claimed in claim 1, characterized in that it comprises means for modifying the contents of the channels.

7. An apparatus as claimed in claim 5, taken as a body, for which said files are files of the MIDI type.

8. An apparatus as claimed in claim 1, comprising means for mixing the sounds of the different channels.

9. An apparatus as claimed in claim 1, comprising means for recording said sounds created by the user in a music file.

10. An apparatus as claimed in claim 9, comprising means for using at least one of the transmission procedures of the SMS, IRDA, electronic mail or other types, and means for using this method for transmitting said music file.

11. An apparatus as claimed in claim 1, comprising a ring tone circuit and means for applying said music file to said ring tone circuit.

12. An apparatus as claimed in claim 1, comprising means for choosing to process a certain number of channels from a multitude of channels.

13. An apparatus as claimed in claim 1, comprising means for receiving a call from a correspondent and means for saving the music files during their realization.
